(19) United States
(12) Patent Application Publication
(10) Pub. No.: US 2010/0243315 A1
(43) Pub. Date: Sep. 30, 2010

(54) Removable Knockout Plate For Enclosures

(75) Inventors: Kevin Shumate, Duluth, GA (US); Amanda Beaton, Alpharetta, GA (US); Fan Zhang, Suwanee, GA (US); Brian J. Rusch, Suwanee, GA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Industry, Inc., Alpharetta, GA (US)

(21) Appl. No.: 12/731,641

(22) Filed: Mar. 25, 2010

Related U.S. Application Data
(60) Provisional application No. 61/164,596, filed on Mar. 30, 2009.

(51) Int. Cl. H02G 3/18

(52) U.S. Cl. 174/666

(57) ABSTRACT

The present invention relates generally to panels or enclosures. More particularly, the invention encompasses a removable knockout plate for enclosures. The present invention is also directed to a novel electrical panel or enclosure where at least a portion of at least one removable plate or panel is removably attached to a frame. The removable plate can be removed and can be cut at desired locations to create holes or openings for electrical components. The removable panel or plate can be a blank plate where at least one opening is created, as needed, or the removable panel can have at least one knockout which can be removed from the removable panel or plate, as needed.

### CROSS-REFERENCE TO RELATED APPLICATION

The instant patent application claims priority to and the benefit of pending U.S. Provisional Patent Application Ser. No. 61/164,596, filed on Mar. 30, 2009, titled “Removable Knockout Plate For Enclosures,” the entire disclosure of which provisional application is incorporated herein by reference.

### FIELD OF THE INVENTION

The present invention relates generally to panels or enclosures. More particularly, the invention encompasses a removable knockout plate for enclosures. The present invention is also directed to a novel electrical panel or enclosure where at least a portion of at least one removable plate or panel is removably attached to a frame. The removable plate can be removed and can be cut at desired locations to create holes or openings for electrical components. The removable panel or plate can be a blank plate where at least one opening is created, as needed, or the removable panel can have at least one knockout which can be removed from the removable panel or plate, as needed.

### BACKGROUND INFORMATION

Contractors/electricians/installers spend hours to knockout knockout holes in an enclosure and then they spend time feeding wire(s) through the holes. This becomes a big problem, especially when dealing with larger size wires, when 3 or 4 electricians have to work together coordinating to feed all wires into the knockout holes. This problem increases, for example, when installing a 3 phase 4 wire modular multi-position metering system. This is due to the fact that enclosures are of a compact size, and with the large amount of wires, it may take one electrician to hold the enclosure in position, one electrician to pull the wire out of the conduit hole, one electrician to hold wires on the other side of the wall to lead the wires straight in, and another electrician who from behind has to push and bend the wire(s). As one can appreciate now that the installation of modular multi-position metering system is very labor intensive, and time consuming. Therefore, there is a need for improvement in electrical panels or enclosures, especially for accommodating electrical components, such as, electrical wires, electrical conduits, to name a few.

U.S. Pat. No. 4,679,867 (Stanley W. Heldenbrand, et al.), the entire disclosure of which is incorporated herein by reference, discloses a cabinet for an electronic apparatus which includes a shelf of removable electronic circuit modules being interconnected by a back plane structure, the cabinet including side walls for supporting the shelf and a rear closure wall detachably fixed to rear edges of the side walls. Connector panels each diagonally straddle rear interior corners at junctions of the rear wall and the side walls to define vertical cable channels. An interconnect cavity behind the back plane structure is defined by a central portion of the rear wall between the connector panels and is limited by upper and lower closure panels at upper and lower ends of the connector panels. Edges of the upper and lower closure panels and the connector panels define a port for convenient physical access to the interconnect cavity when the rear wall is removed. Cable spans between the back plane structure and the connector panels are inherently direct and short, thereby minimizing potential EMI radiation such that feedthrough capacitance of connectors in the connector panel is likewise advantageously minimized.

U.S. Pat. No. 6,751,913 (John R. Marrotte, et al.), the entire disclosure of which is incorporated herein by reference, discloses a wall structure includes at least two studs that are designed to support panels front and back, and end caps or raceway channel defining members on the leading and trailing edges of the panel wall structure. Each of the studs includes sets of oppositely arranged flanges that in turn cooperate with marginal edges of both the panels and the raceway defining members. Cross bracing is provided to allow wiring either within the enclosed space between the panels, or more preferably in the wireways defined in the raceway members so that the power and data communication conductors can be isolated from one another. The feature of the panel structure is that the panels themselves can support light fixtures or other lightweight electrical devices, and heavier electrical devices or units can be accommodated from the cross bracing or from shelves secured to the cross bracing and to the studs. Knockout openings in the studs and in the cross bracing provides for convenience in wiring and in mounting of electrical devices generally.

U.S. Pat. No. 7,286,339 (William C. Baca), the entire disclosure of which is incorporated herein by reference, discloses an underground combination service entrance apparatus for temporary and permanent service comprising two enclosures. A utility enclosure contains a meter socket and the second enclosure contains a breaker panel. The breaker panel on the customer side and the meter on the utility side meet NEC requirements and the local utility company regulations. An optional section in the utility enclosure provides a raceway space for routing wiring. Knockout holes are provided on the utility enclosure for installation of a hub for running wires to and from the service apparatus. The enclosures can be semi-flushed mounted. The two enclosures are isolated from each other, fastened together, and mounted on a wall. A removable hood is provided to weatherproof the customer enclosure for temporary use.

However, this invention improves on the deficiencies of the prior art and provides an inventive removable knockout plate for enclosures.

### PURPOSES AND SUMMARY OF THE INVENTION

The invention is a novel removable knockout plate for enclosures.

Therefore, one purpose of this invention is to provide a removable knockout plate for enclosures.

Another purpose of this invention is to provide at least one removable knockout plate for an electrical panel or enclosure which can be removed in the field and where at least one opening can be created in the removable knockout plate, and where the removable knockout plate with at least one opening is then secured to the frame of the panel or enclosure.

Yet another purpose of this invention is to provide a removable knockout panel or plate having at least one knockout, and where the knockout can be removed when desired.

Still yet another purpose of this invention is to provide a removable panel or plate, where the removable panel or plate is a blank panel or plate, and where one or more openings can be created in the removable panel or plate when desired.

Therefore, in one aspect this invention comprises an electrical apparatus comprising:

(a) an enclosure, said enclosure having at least one back wall, a first side wall, a second side wall, and at least one opening in at least one wall;
(b) a bottom endwall, wherein said bottom endwall is secured to a bottom edge of said enclosure;
(c) a top endwall, wherein said top endwall is secured to a top edge of said enclosure; and
(d) at least one removable plate secured to said enclosure such that said at least one removable plate substantially covers said at least one opening in said at least one wall of said enclosure.

In another aspect this invention comprises an electrical apparatus comprising:

(a) an enclosure, said enclosure having at least one back wall, a first side wall, a second side wall, and at least one opening in at least one wall;
(b) a bottom endwall, wherein said bottom endwall is secured to a bottom edge of said enclosure;
(c) a top endwall, wherein said top endwall is secured to a top edge of said enclosure;
(d) at least one removable plate secured to said enclosure such that said at least one removable plate substantially covers said at least one opening in said at least one wall of said enclosure;
(e) at least one means for removing said at least one removable plate from said enclosure;
(f) at least one means for creating at least one opening in said at least one removable plate; and
(g) at least one means for securing said at least one removable plate with said at least one opening, such that said at least one removable plate substantially covers said at least one opening in said at least on wall of said enclosure.

### BRIEF DESCRIPTION OF THE DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the drawings in which:

FIG. 1, illustrates a perspective view of a first embodiment of an inventive electrical panel or enclosure of this invention.

FIG. 2, illustrates an exploded view of the inventive electrical panel or enclosure of the invention illustrated in FIG. 1.

FIG. 3, illustrates a top view of an inventive removable knockout plate of this invention.

FIG. 4, illustrates a perspective view of a second embodiment of an inventive electrical panel or enclosure of this invention.

### DETAILED DESCRIPTION

This invention provides a convenient provision of a removable knockout plate for an electrical panel or enclosure to flexibly fit the incoming or outgoing wire conduits. This invention also provides the convenience of removing the knockout plate, and the knocking out to proper size conduit for the enclosure. Alternatively, a blank removable plate provides even more flexibility for creating an opening for an enclosure. With this invention one can make conduit openings of any size, at anywhere on the removable plate, so as to fit the installation requirements. This invention will reduce hours of wiring time from regular installation.

It is well known in the art that most commonly in electrical rooms the back wall is usually utilized for exiting the wires so as to ensure clean and neat overall setup. The removable knockout plate of this invention provides a much larger opening (when knockout plate is removed) for installers or contractors to feed wires through. The electrician or installers can also regroup wires in front of the enclosure and cut out knockout holes at designated location(s), and then slide the removable knockout plate with all the wires, now installed, through the designated holes. As one can now appreciate that with this invention only one electrician can do all the wiring on an enclosure with removable knockout plate, and in much less time, when compared to the prior art method where 3 or more electricians were needed when wiring an enclosure without the inventive removable knockout plate.

The removable knockout plate of this invention also alleviates the need for measuring and transposing conduit profiles on a fixed blank wall. This invention also eliminates the time spent awkwardly aligning conduit to a wall with pre-cut knockouts. Furthermore, this invention also allows contractors/electricians/installers to remove the knock-out plate, and then directly transpose conduit profiles after the panel has been hung or mounted onto the wall or similar surface. Cutting the required hole or openings for a conduit, such as, a wire conduit, using this invention is an easier and much more efficient method.

The removable knockout plate of this invention provides a convenient method of passing incoming or outgoing wire conduits through the back of an electrical panel or enclosure. This also allows installing the electrical panel or enclosure before creating the openings, and handling a small knockout plate or panel instead of the entire electrical panel or enclosure when adding openings.

This invention, as stated earlier, comprises of at least one removable knockout plate that can be removed before or after installing an electrical panel or enclosure onto the wall. Removing the knockout plate provides a convenient method for the contractor/electrician/installer to create openings of any size and location required for conduits used while wiring the electrical panel or enclosure. The removable knockout plate can either be blank or consist of knockouts (pre-defined weakened area in a panel used in the industry to create openings as needed) that the contractor/electrician/installer can remove, as needed. This invention will reduce hours of wiring time from an electrical panel or enclosure installation.

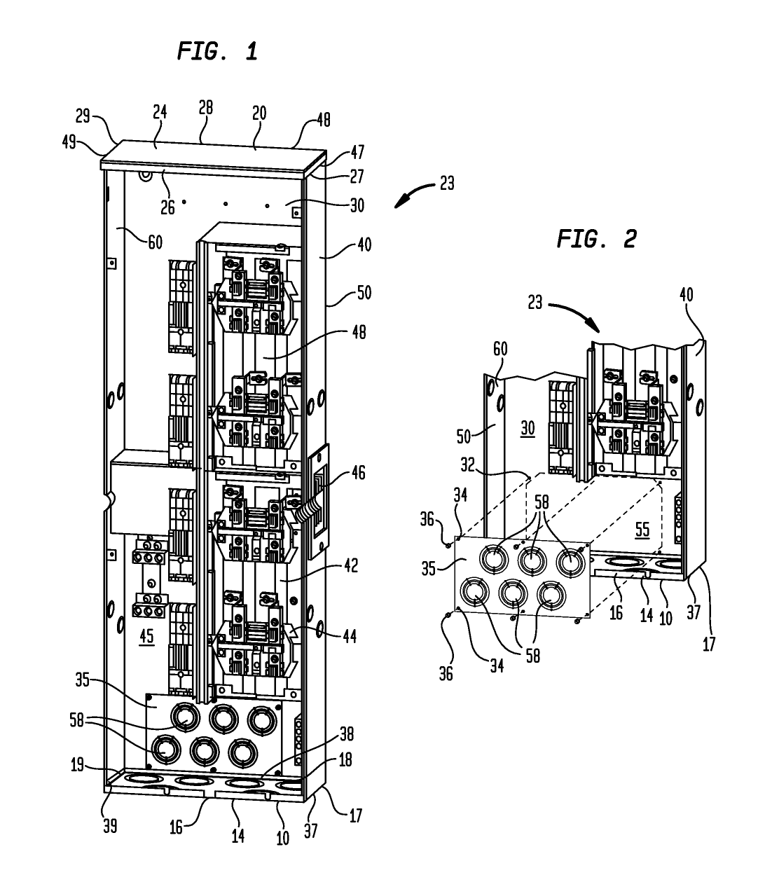

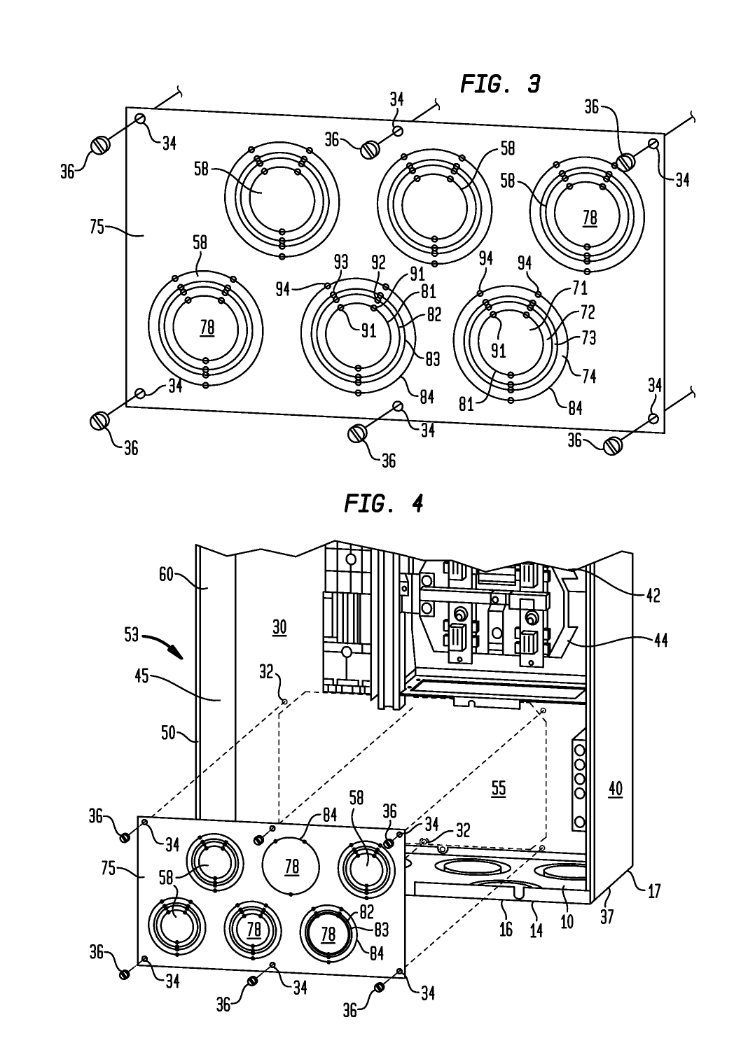

FIG. 1, illustrates a perspective view of a first embodiment of an inventive electrical panel or enclosure 23, of this invention. The electrical panel or enclosure 23, comprises of a base or bottom frame 14, a top or upper frame 24, a wrapper 50, a top endwall 20, and a bottom endwall 10. The base frame 14, comprises of a bottom front frame 16, a bottom first side frame 17, a bottom rear frame 18, and a bottom second side frame 19. The wrapper 50, typically comprises of a first side panel 40, having a bottom side edge 37, and a top side edge 47, a rear or back panel 30, comprising a bottom rear edge 38, and a top rear edge 48, and a second side panel 60, having a bottom side edge 39, and a top side edge 49. For some application the wrapper 50, may have a front panel or front door (not shown). The top or upper frame 24, comprises of a top front frame 26, a top first side frame 27, a top rear or back frame 28, and a top second side frame 29. The bottom frame 14, is permanently secured to the wrapper 50, such that the bottom side edge 37, is secured to the bottom side frame 17, the bottom back edge 38, is secured to bottom back frame 18, and that the bottom side edge 39, is secured to the bottom side frame 19. Similarly, the top frame 24, is permanently secured to the wrapper 50, such that the top side edge 47, is secured to the top side frame 27, the top back edge 48, is secured to top back frame 28, and that the top side edge 49, is secured to the top side frame 29. At least one removable panel or plate 35, is secured to at least one wall of the enclosure 23. For the purposes of illustration the removable plate 35, having at least one knockout 58, is secured to the rear or back panel 30, of the enclosure 23. However, the plate 35, could be a blank panel or plate 35. In a typical installation one would pass incoming or outgoing wire conduits (not shown) through the openings 78 (shown in FIGS. 3 and 4) in the removable knockout plate 35, of the inventive electrical panel or enclosure 23. For the ease of understanding the other electrical and mechanical components of the inventive electrical panel or enclosure 23, are not shown.

For the purposes of illustration the enclosure 23, shown in FIG. 1, could be, for example, a 4 meter position modular metering enclosure 23. The multi-position modular metering enclosure 23, could include a meter section 42, and a tenant section 45. The two sections 42, 45, are enclosed by the enclosure 23, having a bottom endwall 10, a top endwall 20, and a wrapper 50. Due to the application of multi-position modular metering 23, line electrical power is fed through crossing buses 46, to the meter section 42. The riser buses 48, connect the crossing buses 46, to distribute electrical power to individual meter socket 44. A watt-hour meter (not shown) provided by a utility bridges the meter socket line and load to designated load tenant when the enclosure 23, is energized. All tenants in the tenant section 45, are connected to residential panels via load wires running through the removable knockout plate 35, into the walls.

FIG. 2, illustrates an exploded view of the inventive electrical panel or enclosure 23, of the invention illustrated in FIG. 1. FIG. 2, clearly shows the removable knockout plate 35, from the enclosure or wrapper 50. The removable knockout plate 35, can be a blank plate 35, when it is initially assembled. However, the removable knockout plate 35, can have one or more specific sized knockout clusters 58. The removable knockout plate 35, can be removed or assembled to the back panel 30, of the wrapper 50, with the use of hardware or securing means 36. The hardware or securing means 36, can be selected from a group comprising, screws, nuts, bolts, welds, to name a few. The removable knockout plate 35, has at least one opening or location 34, to secure the removable knockout plate 35, to the back panel 30, via at least one securing means 36. The back panel 30, has at least one opening or location 32, to secure the removable knockout plate 35, to the back panel 30, via at least one securing means 36. Thus, the removable knockout plate 35, is a removable panel or plate 35, from the inventive electrical panel or enclosure 23. As one can see that the back panel 30, has at least one opening or cutoff 55, which opening or cutoff 55, is covered when the removable knockout plate 35, is secured to the back panel 30, using at least one securing means 36. It is preferred that the back panel 30, has at least one hole or location 32, which mates with or corresponds with at least one hole or location 34, on the removable knockout panel 35, so that the securing means 36, uses locations 32, and 34, to secure the removable knockout panel 35, to the back panel 30.

As stated earlier FIG. 2, shows an exploded view of a removable knockout plate 35, and a cutoff 55, on the back panel 30, of the enclosure 23. The removable knockout plate 35, can have a plurality of specific sized knockout clusters 58, or a blank plate 35, with at least one mounting hole or location 34. On the back of the wrapper 50, a maximal sized cutoff 55, with at least one mounting provision 32, fits the removable knockout plate 35. Fastening means 36, such as, screws 36, securely attach the removable knockout plate 35, onto the back panel 30, of the wrapper 50, at the designated locations so as to cover the opening or cutoff 55.

FIG. 3, illustrates a top view of an inventive removable knockout plate 75, of this invention. The removable knockout plate 75, is similar to the removable knockout plate 35, however, the removable knockout plate 75, has either at least one knockout 58, or at least one hole or opening 78. The removable knockout plate 75, could have at least one opening or location 34, for securing the removable knockout plate 75, to the back panel 30, of the inventive electrical panel or enclosure 23, using at least one securing means 36. The knockout 58, could comprise of one or more knockouts, such as, knockout 71, 72, 73, 74, having a weakened outline 81, 82, 83, 84, respectively. The knockouts 71, 72, 73, 74, could also have one or more perforations or tabs 91, 92, 93, 94, respectively, along the weakened outline 81, 82, 83, 84, respectively. This concept of a knockout within a knockout allows an operator or installer to select the opening that is desired and remove each knockout as desired or needed for the application. Additionally, having one or more perforations or tabs 91, 92, 93, 94, along the knockout outline or weakened area, allows an installer to easily pop-out a knockout from the removable knockout panel 35, 75, without the use of specialized tools.

FIG. 4, illustrates a perspective view of a second embodiment of an inventive electrical panel or enclosure 53, of this invention. The electrical panel or enclosure 53, is similar to the enclosure 23, however it has at least one removable knockout plate 75, secured to a back panel 30, in the area of the cutoff or opening 55. The removable knockout plate 75, could have at least one knockout 58, or at least one hole or opening 78. However, the removable knockout plate 75, could be similar to removable knockout plate 35. As shown in FIGS. 1 and 2, the removable knockout plate 35, does not have an opening, however, when desired, an operator could remove the removable knockout plate 75, and creating one or more opening 78. As one can appreciate that it is rather easy for an operator to remove knockout plate 35, 75, and then work on the removable knockout plate 35, 75, as desired, and then easily secure the removable knockout plate 35, 75, back into the back frame 30. With this invention an operator does not have to manipulate the whole electrical panel or enclosure 23, 53, but only the removable knockout plate 35, 75. The opening 78, can be made by methods well known in the art, such as, for example, using a saw, a snip, a cutter, a laser beam, or any other device or tool that can cut a hole or opening in a panel or plate or knockout plate 35, 75.

The shape of the hole or opening 78, could be selected from a group comprising, a square shape, a circular shape, an elliptical shape, a triangular shape, a polygonal shape, a jagged shape, to name a few.

The shape of the knockout 58, could be selected from a group comprising, a square shape, a circular shape, an elliptical shape, a triangular shape, a polygonal shape, a jagged shape, to name a few.

The material for the removable knockout plate 35, could be selected from a group comprising, a metallic material, a plastic material, a fiberglass material, a rubber material, a composite material, to name a few.

The material for the wrapper 50, could be selected from a group comprising, a metallic material, a plastic material, a fiberglass material, a rubber material, a composite material, to name a few.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. An electrical apparatus comprising:
(a) an enclosure, said enclosure having at least one back wall, a first side wall, a second side wall, and at least one opening in at least one wall;
(b) a bottom endwall, wherein said bottom endwall is secured to a bottom edge of said enclosure;
(c) a top endwall, wherein said top endwall is secured to a top edge of said enclosure; and
(d) at least one removable plate secured to said enclosure such that said at least one removable plate substantially covers said at least one opening in said at least one wall of said enclosure.

2. The electrical apparatus of claim 1, wherein material for said enclosure is selected from a group consisting of a metallic material, a plastic material, a fiberglass material, a rubber material, and a composite material.

3. The electrical apparatus of claim 1, wherein material for said removable plate is selected from a group consisting of a metallic material, a plastic material, a fiberglass material, a rubber material, and a composite material.

4. The electrical apparatus of claim 1, wherein said removable plate is a blank removable plate.

5. The electrical apparatus of claim 1, wherein said removable plate is a blank removable plate, and wherein at least one opening is made in said blank removable plate using at least one tool selected from a group consisting of a saw, a snip, a cutter, a laser beam, and a device for creating a hole in a plate.

6. The electrical apparatus of claim 1, wherein said removable plate has at least one knockout.

7. The electrical apparatus of claim 1, wherein said removable plate has at least one knockout, and wherein the shape of said at least one knockout is selected from a group consisting of a square shape, a circular shape, an elliptical shape, a triangular shape, a polygonal shape, and a jagged shape.

8. The electrical apparatus of claim 1, wherein said at least one removable plate is secured to said enclosure using at least one securing means, and wherein said at least one securing means is selected from a group consisting of a screw, a nut, a bolt, and a weld.

9. The electrical apparatus of claim 1, wherein the shape of said opening in said wall is selected from a group consisting of a square shape, a circular shape, an elliptical shape, a triangular shape, a polygonal shape, and a jagged shape.

10. The electrical apparatus of claim 1, wherein said enclosure has at least one location for accommodating at least one electrical component, and wherein said at least one electrical component is selected from a group consisting of a riser bus, cross bus, a meter section, a tenant section, a meter socket, and a meter.

11. An electrical apparatus comprising:
(a) an enclosure, said enclosure having at least one back wall, a first side wall, a second side wall, and at least one opening in at least one wall;
(b) a bottom endwall, wherein said bottom endwall is secured to a bottom edge of said enclosure;
(c) a top endwall, wherein said top endwall is secured to a top edge of said enclosure;
(d) at least one removable plate secured to said enclosure such that said at least one removable plate substantially covers said at least one opening in said at least one wall of said enclosure;
(e) at least one means for removing said at least one removable plate from said enclosure;
(f) at least one means for creating at least one opening in said at least one removable plate; and
(g) at least one means for securing said at least one removable plate with said at least one opening, such that said at least one removable plate substantially covers said at least one opening in said at least on wall of said enclosure.

12. The electrical apparatus of claim 11, wherein material for said enclosure is selected from a group consisting of a metallic material, a plastic material, a fiberglass material, a rubber material, and a composite material.

13. The electrical apparatus of claim 11, wherein material for said removable plate is selected from a group consisting of a metallic material, a plastic material, a fiberglass material, a rubber material, and a composite material.

14. The electrical apparatus of claim 11, wherein said removable plate is a blank removable plate.

15. The electrical apparatus of claim 11, wherein said removable plate is a blank removable plate, and wherein at least one opening is made in said blank removable plate using at least one tool selected from a group consisting of a saw, a snip, a cutter, a laser beam, and a device for creating a hole in a plate.

16. The electrical apparatus of claim 11, wherein said removable plate has at least one knockout.

17. The electrical apparatus of claim 11, wherein said removable plate has at least one knockout, and wherein the shape of said at least one knockout is selected from a group consisting of a square shape, a circular shape, an elliptical shape, a triangular shape, a polygonal shape, and a jagged shape.

18. The electrical apparatus of claim 11, wherein said at least one removable plate is secured to said enclosure using at least one securing means, and wherein said at least one securing means is selected from a group consisting of a screw, a nut, a bolt, and a weld.

19. The electrical apparatus of claim 11, wherein the shape of said opening in said wall is selected from a group consisting of a square shape, a circular shape, an elliptical shape, a triangular shape, a polygonal shape, and a jagged shape.

20. The electrical apparatus of claim 11, wherein said enclosure has at least one location for accommodating at least one electrical component, and wherein said at least one electrical component is selected from a group consisting of a riser bus, cross bus, a meter section, a tenant section, a meter socket, and a meter.
